(19) United States
(12) Patent Application Publication
(10) Pub. No.: US 2019/0248199 A1
(43) Pub. Date: Aug. 15, 2019

(54) SUSPENSION ARM AND MANUFACTURING METHOD THEREFOR

(71) Applicant: TOYOTA JIDOSHA KABUSHIKI KAISHA, Toyota-shi (JP)

(72) Inventors: Katsuhiko KOJIMA, Chiryu-shi (JP); Takaaki NAGATANI, Okazaki-shi (JP)

(73) Assignee: TOYOTA JIDOSHA KABUSHIKI KAISHA, Toyota-shi (JP)

(21) Appl. No.: 16/240,845

(22) Filed: Jan. 7, 2019

(30) Foreign Application Priority Data
Feb. 9, 2018 (JP) 2018-021805

(51) Int. Cl. B60G 7/00; F16C 7/02

(52) U.S. Cl. CPC B60G 7/001; F16C 7/02; B33Y 10/00; F16C 2326/05; B60G 2206/121

(57) ABSTRACT

A suspension arm includes a rod-like arm part, and a cylindrical collar part integrally formed with the arm part at an end of the arm part. A hollow part with a hollow formed inside thereof is formed along an axial direction of the arm part in the arm part. A communicating hole communicating between a space inside the collar part and the hollow part is formed in a connecting part of the collar part, the connecting part of the collar part connecting with the end of the arm part. The communicating hole is formed so as to be centered on a central axis of the arm part, the central axis of the arm part being a line connecting centroids of cross-sectional shapes with one another in the axial direction of the arm part, the cross-sectional shapes being shapes on cross-sectional planes perpendicular to an axis of the arm part.

### CROSS REFERENCE TO RELATED APPLICATIONS

This application is based upon and claims the benefit of priority from Japanese patent application No. 2018-021805, filed on Feb. 9, 2018, the disclosure of which is incorporated herein in its entirety by reference.

### BACKGROUND

The present disclosure relates to a suspension arm and its manufacturing method.

A suspension arm including a rod-shaped arm part and cylindrical collar parts welded at ends of the arm part has been known (see Japanese Unexamined Patent Application Publication No. 2013-032158). A slit is formed in the arm part to reduce its weight and lower its torsional rigidity.

In the aforementioned suspension arm, the collar parts are welded to the ends of the arm part. Therefore, a stress is concentrated on this welded part and hence its durability tends to be impaired. Meanwhile, it is possible to integrally form (e.g., integrally mold) the arm part and the collar parts by using a 3D (three-dimensional) printer or the like.

However, the present inventors have found the following problem. When a hollow structure is used for the arm part in order to reduce its weight, it is necessary to form a hole in the arm part so that support material can be pulled out (i.e., removed) from the inside of the hollow structure through the hole (hereinafter referred to as the removal hole). When a new removal hole is formed, a stress tends to be concentrated on the place where the removal hole is formed and hence durability of the arm part may be impaired. Therefore, there is a need for a suspension arm capable of having improved durability and having reduced weight.

### SUMMARY

The present disclosure has been made in order to solve the above-described problem and a main object thereof is to provide a suspension arm capable of having improved durability and having reduced weight, and its manufacturing method.

A first exemplary aspect to achieve the above-described object is a suspension arm including a rod-like arm part, and a cylindrical collar part integrally formed with the arm part at an end of the arm part, in which

a hollow part with a hollow formed inside thereof is formed along an axial direction of the arm part in the arm part,

a communicating hole communicating between a space inside the collar part and the hollow part is formed in a connecting part of the collar part, the connecting part of the collar part connecting with the end of the arm part, and

the communicating hole is formed so as to be centered on a central axis of the arm part, the central axis of the arm part being a line connecting centroids of cross-sectional shapes with one another in the axial direction of the arm part, the cross-sectional shapes being shapes on cross-sectional planes perpendicular to an axis of the arm part.

In this aspect, a diameter of the arm part may gradually increase toward the collar part and a maximum diameter of the arm part may be equal to an outer diameter of the collar part.

In this aspect, at least one underfill part may be formed in the arm part so that the central axis of the arm part coincides with a load line of the arm part, the load line of the arm part indicating a line on which a load is imposed in the arm part.

Another exemplary aspect to achieve the above-described object may be a method for manufacturing a suspension arm including a rod-like arm part, and a cylindrical collar part integrally formed with the arm part at an end of the arm part, in which

a hollow part with a hollow formed inside thereof is formed along an axial direction of the arm part in the arm part,

a communicating hole communicating between a space inside the collar part and the hollow part is formed in a connecting part of the collar part, the connecting part of the collar part connecting with the end of the arm part, and

the communicating hole is formed so as to be centered on a central axis of the arm part, the central axis of the arm part being a line connecting centroids of cross-sectional shapes with one another in the axial direction of the arm part, the cross-sectional shapes being shapes on cross-sectional planes perpendicular to an axis of the arm part.

In this aspect, the arm part and the collar part may be integrally formed (e.g., integrally molded) by a 3D printer.

According to the present disclosure, it is possible to provide a suspension arm capable of having improved durability and having reduced weight, and its manufacturing method.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a perspective view showing a schematic configuration of a suspension arm according to a first embodiment of the present disclosure;

FIG. 2 is a cross section taken on a plane A in the suspension arm shown in FIG. 1;

FIG. 3 is a cross section of the suspension arm taken on a plane perpendicular to the plane A shown in FIG. 2, i.e., taken along a line B-B in FIG. 2;

FIG. 4 shows an arm part having a hollow structure;

FIG. 5 shows a cross section of a suspension arm according to a second embodiment of the present disclosure;

FIG. 6 is a perspective view showing a suspension arm according to a third embodiment of the present disclosure;

FIG. 7 is a cross section taken on a plane A in the suspension arm shown in FIG. 6; and

FIG. 8 is a cross section taken on a plane B in the suspension arm shown in FIG. 6.

### DESCRIPTION OF EMBODIMENTS

### First Embodiment

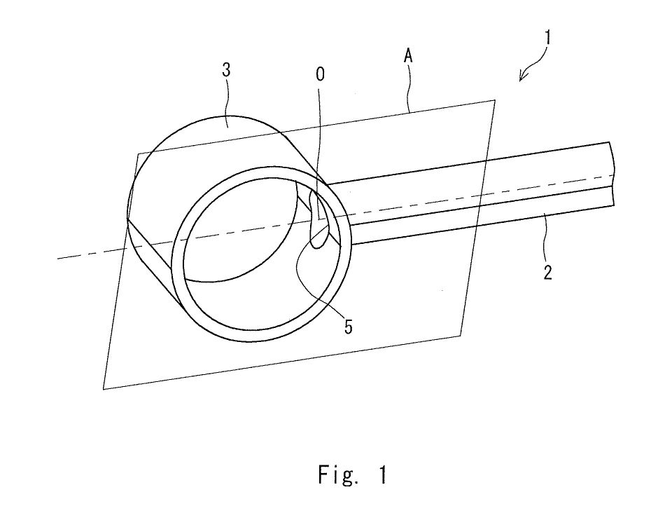

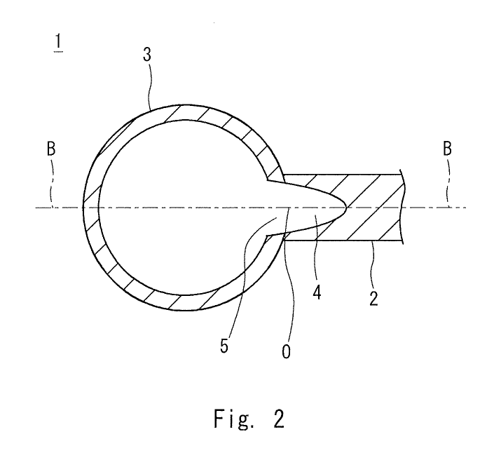

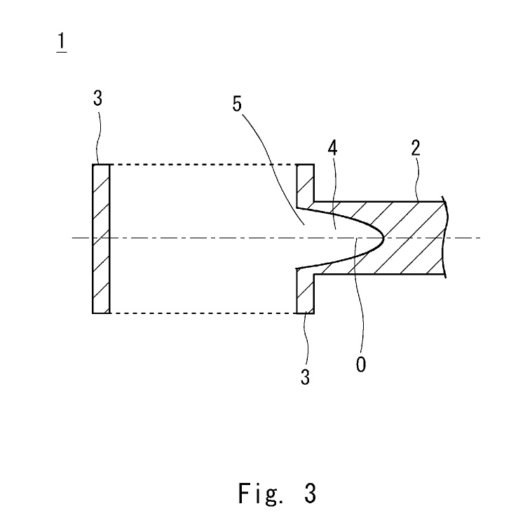

Embodiments according to the present disclosure will be described hereinafter with reference to the drawings. FIG. 1 is a perspective view showing a schematic configuration of a suspension arm according to a first embodiment of the present disclosure. FIG. 2 is a cross section taken on a plane A in the suspension arm shown in FIG. 1. FIG. 3 is a cross section of the suspension arm taken on a plane perpendicular to the plane A shown in FIG. 2, i.e., taken along a line B-B in FIG. 2.

A suspension arm 1 according to the first embodiment includes a rod-shaped arm part 2 and cylindrical collar parts 3 formed at ends of the arm part 2. The arm part 2 and the collar parts 3 are integrally formed (e.g., integrally molded) by using, for example, a 3D (three-dimensional) printer. The 3D printer is an apparatus that forms (e.g., molds) a 3D (three-dimensional) suspension arm 1 by stacking its cross-sectional shapes one another through an adding process by using an additive manufacturing method or the like while using 3D data of the suspension arm 1 created on a computer as a design blueprint. Note that since the configuration of the 3D printer or the like is well known, detailed descriptions thereof are omitted. It should be noted that in a related-art suspension arm, collar parts are welded to ends of an arm part. Therefore, a stress is concentrated on this welded part and hence its durability tends to be impaired.

In contrast to this, in the suspension arm 1 according to the first embodiment, the arm part 2 and the collar parts 3 are integrally formed (e.g., integrally molded) by using a 3D printer as described above. As a result, the connection parts between the ends of the arm part 2 and the collar parts 3 are integrally formed and hence a stress is less likely to be concentrated on these connection parts. Therefore, it is possible to improve durability of the suspension arm 1. Further, by eliminating the need for a welding process while ensuring the compression strength and tensile strength of the suspension arm 1, it is possible to eliminate excessive material which would otherwise be caused by the welding process and thereby to reduce the weight of the suspension arm 1.

Further, as shown in FIGS. 2 and 3, a hollow part 4 with a hollow formed inside thereof is formed at an end of the arm part 2 in the suspension arm 1 according to the first embodiment. The hollow part 4 is formed in such a manner that a hollow having a predetermined length is formed along the axial direction of the arm part 2 at the end of the arm part 2. By making the end of the arm part 2 hollow as described above, it is possible to reduce the weight of the suspension arm 1.

Note that as described above, when the hollow part 4 is formed in the arm part 2 by using a 3D printer, it is necessary to newly form a removal hole in the arm part 2 so that support material can be pulled out (i.e., removed) from the hollow part 4 through the removal hole. In related art, a stress tends to be concentrated on the place where this removal hole is formed and hence durability of the arm part may be impaired.

To solve this problem, in the suspension arm 1 according to the first embodiment, a communicating hole 5 that communicates between a space inside the collar part 3 and the hollow part 4 is formed in a connecting part of the collar part 3 that connects with the end of the arm part 2. Further, the communicating hole 5 is formed so as to be centered on a central axis O of the arm part 2, which is a line connecting centroids of cross-sectional shapes of the arm part 2, which are shapes on cross-sectional planes perpendicular to the axis of the arm part 2, with one another in the axial direction of the arm part 2.

In the case where the suspension arm 1 is formed by using a 3D printer as described above, support material can be pulled out (i.e., removed) from the hollow part 4 through this communicating hole 5. Further, the communicating hole 5 is formed so as to be centered on the central axis O of the arm part 2, which connects centroids (centers of gravity) with one another. Therefore, since the suspension arm 1 becomes less likely to be buckled (less likely to be bent in an awkward direction) at the place where this communicating hole 5 is formed, a stress is less likely to be concentrated and hence durability of the suspension arm 1 can be improved. That is, it is possible to increase the durability of the suspension arm 1 and reduce the weight thereof. Note that since the part where the end of the arm part 2 is connected with the collar part 3 is deviated from the centroid, the strength and robustness of the suspension arm 1 can be ensured.

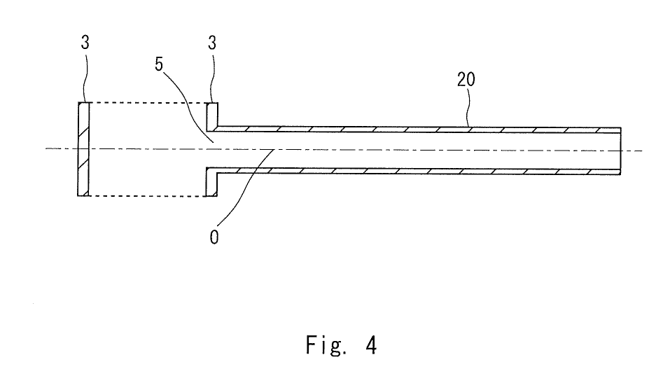

In the first embodiment, the arm part 2 has a solid structure and the hollow part 4 is formed at an end of the arm part 2. However, the configuration of the arm part 2 is not limited to this configuration. For example, as shown in FIG. 4, an arm part 20 has a hollow structure and a hollow part may be formed over the entire length of the arm part 20. In which way, the weight of the suspension arm 1 can be further reduced.

In the first embodiment, although the communicating hole 5 is formed so as to be centered on the central axis O in the connection part between the end of the arm part 2 and the collar part 3. However, the configuration of the suspension arm 1 is not limited to this configuration. For example, a communicating hole for removing support material may be formed so as to be centered on the central axis O at the end of the arm part 2 opposite to the end thereof at which the collar part 3 is connected.

Next, a method for manufacturing a suspension arm 1 according to the first embodiment of the present disclosure is described. The suspension arm 1 is integrally formed (e.g., integrally molded) by a 3D printer. For example, 3D (three-dimensional) data of the suspension arm 1 is stored in advance in a memory or the like. As described above, the 3D data is set (e.g., created) so that a communicating hole 5 is formed so as to be centered on the central axis O.

The 3D printer drives its nozzle based on the 3D data of the suspension arm 1 stored in the memory, and thereby discharges (e.g., spews out) a powder of metal, ceramic, nylon, or the like from the nozzle toward an area(s) corresponding to the cross-sectional shape of the arm part 2 and the collar part 3, and discharges (e.g., spews out) support material toward an area(s) other than the cross-sectional shape of the arm part 2 and the collar part 3. Then, the 3D printer drives a laser apparatus so that it applies high-power laser to the area(s) corresponding to the cross-sectional shape of the arm part 2 and the collar part 3, and thereby forms (e.g., molds) the cross-sectional shape in each layer.

By repeating the above-described process, the 3D printer stacks the cross-sectional shape of each layer and thereby forms (e.g., molds) a desired suspension arm 1. Lastly, the 3D printer removes the support material deposited in space inside the hollow part 4 of the arm part 2 as well as the support material deposited around the arm part 2 and the collar part 3 through the communicating hole 5.

As described above, since the arm part 2 and the collar part 3 are integrally formed (e.g., integrally molded) in the first embodiment, a stress is less likely to be concentrated on the connection part between the arm part 2 and the collar 3 and hence the durability of the suspension arm is improved. Further, by forming the hollow part 4 in the arm part 2, the weight of the suspension arm 1 can be reduced. Further, the communicating hole 5 that communicates between a space inside the collar part 3 and the hollow part 4 is formed in the connecting part of the collar part 3 that connects with the end of the arm part 2. Furthermore, the communicating hole 5 is formed so as to be centered on the central axis O, which connects centroids with one another. As a result, support material can be pulled out (i.e., removed) from the hollow part 4 through the communicating hole 5 and, in addition, a stress is less likely to be concentrated on this communicating hole 5. Consequently, the durability of the suspension arm 1 can be improved. That is, it is possible to increase the durability of the suspension arm 1 and reduce the weight thereof.

### Second Embodiment

In the above-described first embodiment, the arm part 2 is a rod-shaped component having a constant diameter. In contrast, a diameter of an arm part may increase toward a collar part in a second embodiment.

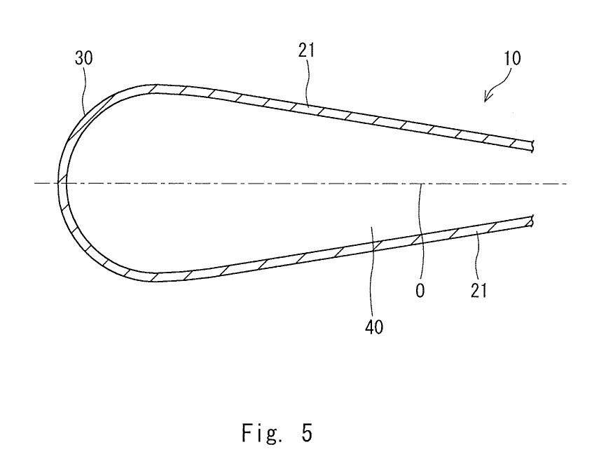

FIG. 5 shows a cross section of a suspension arm according to the second embodiment of the present disclosure. In a suspension arm 10 according to the second embodiment, a diameter of an arm part 21 gradually increases toward a collar part 30 (i.e., gradually increases as the distance from the collar part 30 decreases). Further, a maximum diameter of an end of the arm part 21 is equal to an outer diameter of the collar part 30.

It is possible to increase the strength of the arm part 21 by increasing the diameter of the arm part 21 toward the collar part 30 (i.e., increasing the diameter of the arm part 21 in such a manner that the closer the arm part 21 is to the collar part 30, the larger the diameter of the arm part 21 becomes) and thereby making the arm part 21 thicker. Since the hollow part 40 is formed in the arm part 21, an increase in the weight of the arm part 21 can be minimized even when the diameter of the end part of the arm part 21 is increased. That is, it is possible to reduce the weight of the arm part 21 while increasing the strength thereof.

### Third Embodiment

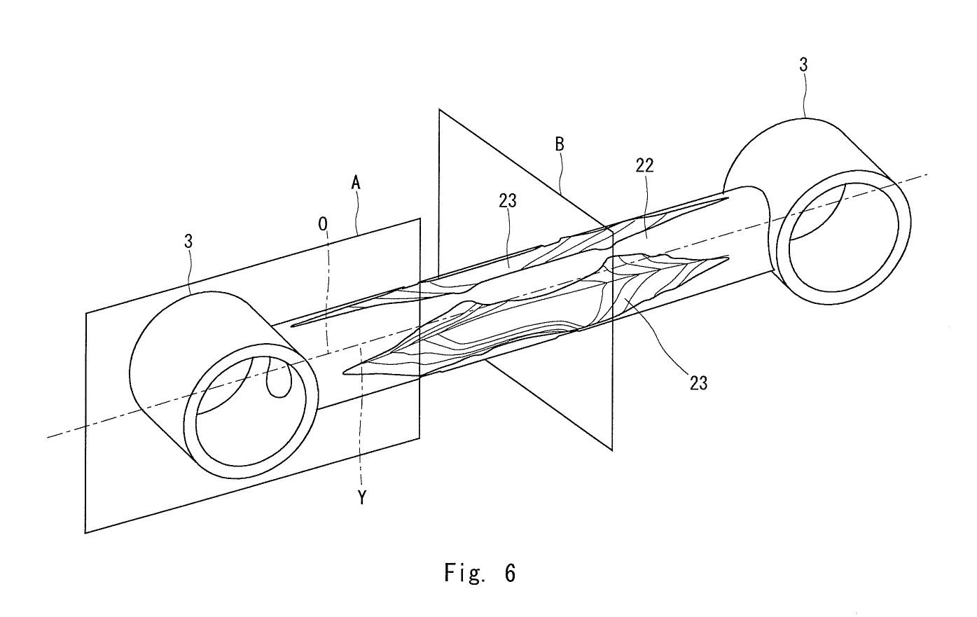

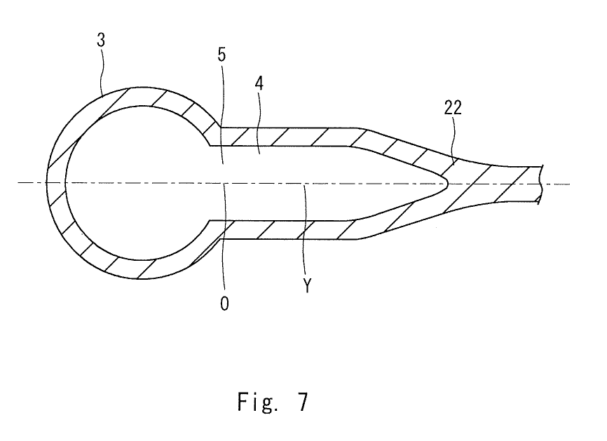

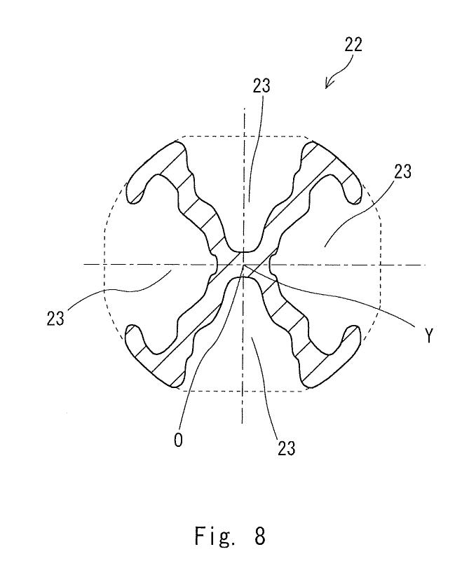

FIG. 6 is a perspective view showing a suspension arm according to a third embodiment of the present disclosure. FIG. 7 is a cross section taken on a plane A in the suspension arm shown in FIG. 6. FIG. 8 is a cross section taken on a plane B in the suspension arm shown in FIG. 6.

In the third embodiment, at least one underfill part 23 is formed in an arm part 22 so that a central axis O of the arm part 22 coincides with (i.e., aligns with) a load line Y of the arm part 22. The load line Y of the arm part 22 is a line on which a load is imposed in the arm part 22, i.e., a line that a force passes through when a load is imposed on the arm part 22. For example, the load line Y of the arm part 22 is a straight line that connects a fixed point at which the arm part 22 is fixed with a load point at which a load is imposed on the arm part 22 in the longitudinal direction of the arm part 22.

By forming underfill parts 23 in the arm part 22, it is possible to optimally reduce torsional rigidity of the arm part 22 while reducing the weight of the arm part 22. Further, by making the central axis O and the load line Y of the arm part 22 coincident with each other (i.e., aligned with each other), it is possible to prevent the strength of the arm part 22 from changing suddenly and thereby to prevent the stress from being concentrated in the arm part 22. That is, it is possible to reduce the torsional rigidity of the arm part 22 and sustain the durability thereof at the same time.

Next, a method for setting (i.e., defining) underfill parts according to the third embodiment is described.

At least one underfill part 23 is formed in the arm part 22 so that the central axis O and the load line Y of the arm part 22 coincide with each other.

For example, when the size of the cross-sectional shape of the underfill parts 23 is increased and the size of the cross-sectional shape of the arm part 22 is decreased, torsional rigidity of the arm part 22 decreases. Conversely, when the size of the cross-sectional shape of the underfill parts 23 is decreased and the size of the cross-sectional shape of the arm part 22 is increased, the torsional rigidity of the arm part 22 increases.

Similarly when the length of the underfill parts 23 in the axial direction of the arm part 22 is increased, the torsional rigidity of the arm part 22 decreases. Conversely, when the length of the underfill parts 23 in the axial direction of the arm part 22 is decreased, the torsional rigidity of the arm part 22 increases. Note that the length of the underfill parts 23 can be increased as long as the underfill parts 23 do not reach the collar part 3. This is because, for example, when the underfill part 23 extends to the collar part 3, a stress tends to be concentrated on a place where the underfill part 23 intersects (i.e., connects with) the collar part 3.

In view of the above-described matters, the underfill parts 23 are set (i.e., defined) in the arm part 22 so that the torsional rigidity of the arm part 22 has a predetermined value and the central axis O and the load line Y of the arm part 22 coincide with each other.

For example, as shown in FIG. 8, the underfill parts 23 may be formed so that the cross-sectional shape of the arm part 22 becomes a roughly X-shape. The underfill parts 23 are formed so that their cross-sectional shapes become roughly symmetrical to each other. Even when the underfill parts 23 are formed so that the cross-sectional shape of the arm part 22 becomes a roughly X-shape, the cross-sectional area necessary for the arm part 22 is secured.

Further, since the central axis O and the load line Y of the arm part 22 coincide with each other (i.e., are aligned with each other), the arm part 22 has a structure with which the arm part 22 is less likely to be buckled. As a result, it is possible to optimally reduce the torsional rigidity of the arm part 22 so that a torsional deformation occurs in a flexible and satisfactory manner while ensuring the tensile strength and the compressive strength of the arm part 22.

Several embodiments according to the present disclosure have been explained above. However, these embodiments are shown as examples but are not shown to limit the scope of the disclosure. These novel embodiments can be implemented in various forms. Further, their components/structures may be omitted, replaced, or modified without departing from the scope and spirit of the disclosure. These embodiments and their modifications are included in the scope and the spirit of the disclosure, and included in the scope equivalent to the disclosure specified in the claims.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A suspension arm comprising a rod-like arm part, and a cylindrical collar part integrally formed with the arm part at an end of the arm part, wherein
a hollow part with a hollow formed inside thereof is formed along an axial direction of the arm part in the arm part,
a communicating hole communicating between a space inside the collar part and the hollow part is formed in a connecting part of the collar part, the connecting part of the collar part connecting with the end of the arm part, and
the communicating hole is formed so as to be centered on a central axis of the arm part, the central axis of the arm part being a line connecting centroids of cross-sectional shapes with one another in the axial direction of the arm part, the cross-sectional shapes being shapes on cross-sectional planes perpendicular to an axis of the arm part.

2. The suspension arm according to claim 1, wherein a diameter of the arm part gradually increases toward the collar part and a maximum diameter of the arm part is equal to an outer diameter of the collar part.

3. The suspension arm according to claim 1, wherein at least one underfill part is formed in the arm part so that the central axis of the arm part coincides with a load line of the arm part, the load line of the arm part indicating a line on which a load is imposed in the arm part.

4. A method for manufacturing a suspension arm comprising a rod-like arm part, and a cylindrical collar part integrally formed with the arm part at an end of the arm part, wherein
a hollow part with a hollow formed inside thereof is formed along an axial direction of the arm part in the arm part,
a communicating hole communicating between a space inside the collar part and the hollow part is formed in a connecting part of the collar part, the connecting part of the collar part connecting with the end of the arm part, and
the communicating hole is formed so as to be centered on a central axis of the arm part, the central axis of the arm part being a line connecting centroids of cross-sectional shapes with one another in the axial direction of the arm part, the cross-sectional shapes being shapes on cross-sectional planes perpendicular to an axis of the arm part.

5. The method for manufacturing a suspension arm according to claim 4, wherein the arm part and the collar part are integrally formed by a 3D printer.
